(19) United States
(12) Patent Application Publication
(10) Pub. No.: US 2025/0390927 A1
(43) Pub. Date: Dec. 25, 2025

(54) Machine-Learning Prediction of Nutritional Preferences for a User of an Online System

(71) Applicant: Maplebear Inc., San Francisco, CA (US)

(72) Inventors: Madeline Mesard, New York, NY (US); Brent Scheibelhut, Toronto (CA); Charles Wesley, San Diego, CA (US); Naval Shah, Toronto (CA)

(21) Appl. No.: 18/749,933

(22) Filed: Jun. 21, 2024

(51) Int. Cl. G06Q 30/0601; G06Q 30/0201

(52) U.S. Cl. CPC G06Q 30/0631; G06Q 30/0201; G06Q 30/0627; G06Q 30/0643

(57) ABSTRACT

A trained model is used to generate a user interface of an online system based on predicted nutritional preferences for a user of the online system. Upon receiving a signal indicating interaction of the user with the online system, the online system applies the trained model to output, based on user's features, item features and/or session features, a vector of scores for the user, where each score is indicative of a preference of the user for a respective nutritional attribute of a set of nutritional attributes. Responsive to a score being greater than a threshold score, the online system generates, based on the received signal, a user interface of a device associated with the user that includes a label about the nutritional attribute associated with the score. The online system causes the device associated with the user to display the user interface with the label about the nutritional attribute.

### BACKGROUND

Users of online systems often have specific nutritional needs and preferences. However, the online systems currently lack flexibility and personalization to easily identify and surface these nutrition preferences to users. Without self-reporting or other highly manual processes, it is currently not feasible to identify the user's nutrition preferences at a large enough scale required by an online system. Accordingly, alternative mechanisms for doing this are needed.

### SUMMARY

One or more embodiments of the present disclosure are directed to training a machine-learning model of an online system to predict preferences for nutritional attributes of items for a user of the online system.

In accordance with one or more aspects of the disclosure, the online system receives, via a network from a device associated with a user of the online system, a signal indicating interaction of the user with the online system. In response to the received signal, the online system accesses a nutritional prediction machine-learning model of the online system, wherein the nutritional prediction machine-learning model is trained to predict preferences of the user for a set of nutritional attributes. The online system applies the nutritional prediction machine-learning model to output, based on at least one of a first set of features for the user, a second set of features for a set of items, and a third set of features for a current session of the user, a vector of scores for the user, each score from the vector of scores indicative of a preference of the user for a respective nutritional attribute of the set of nutritional attributes. The online system compares each score from the vector of scores with a threshold score. Responsive to a score from the vector of scores being greater than the threshold score, the online system generates, based at least in part on the received signal, a user interface of the device associated with the user that includes label about the nutritional attribute associated with the score. The online system causes the device associated with the user to display the generated user interface with the label about the nutritional attribute.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example smart shopping cart associated with an online system, in accordance with one or more embodiments.

FIG. 4A illustrates an example user interface with an image of an item displayed at a device associated with a user of an online system based on user's predicted preferences for nutritional attributes of the item, in accordance with one or more embodiments.

FIG. 4B illustrates another example user interface with an image of an item displayed at a device associated with a user of an online system based on user's predicted preferences for nutritional attributes of the item, in accordance with one or more embodiments.

FIG. 5 illustrates an example architectural flow diagram of using a trained machine-learning model of an online system to predict preferences for nutritional attributes of items for a user of the online system, in accordance with one or more embodiments.

FIG. 6 is a flowchart for a method of using a trained machine-learning model of an online system to predict preferences for nutritional attributes of items for a user of the online system, in accordance with one or more embodiments.

### DETAILED DESCRIPTION

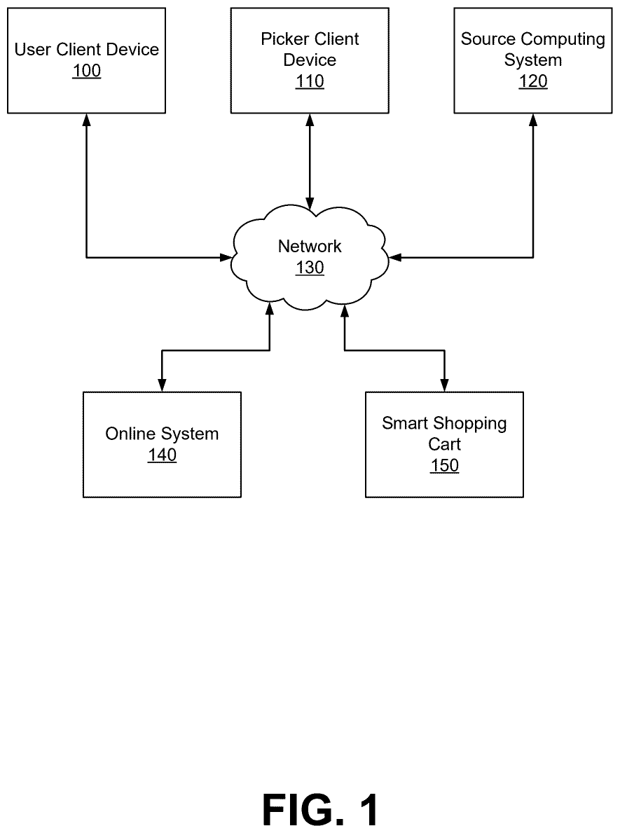

FIG. 1 illustrates an example system environment for an online system 140, in accordance with one or more embodiments. The system environment illustrated in FIG. 1 includes a user client device 100, a picker client device 110, a source computing system 120, a network 130, an online system 140, and a smart shopping cart 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with the smart shopping cart 150 being used by a user to collect items in a source location. For example, the smart shopping cart 150 may display content received from the online system 140 and may receive data describing items that are collected by the user and stored in a storage area of the shopping cart. In some embodiments, the smart shopping cart 150 is a picker client device 110 being operated by a picker collecting items within a source location. Similarly, the smart shopping cart 150 may be operated by a user within the source location collecting items for themselves. Example embodiments of smart shopping carts 150 are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 observes interactions of a user of the online system 140 with items and trains a model (e.g., machine-learning model) that predicts what the user cares about with respect to nutritional attributes of the items. The trained model may receive various inputs including user's purchase history and associated nutritional information, health attributes in past queries, and other user's interactions with the online system 140. The online system 140 then deploys the trained model to determine whether to show specific nutritional information associated with food items to a specific user, to rank food items for the user, to filter out food items that are incompatible with the user's health needs or goals, etc. The online system 140 may thus use the trained model to highlight certain nutritional attributes to users of the online system 140 who are predicted to care about these nutritional attributes.

The trained model of the online system 140 presented herein may thus predict what users care about with regard to the item attributes of their groceries, and make that information more accessible and personalized, by enhancing where those attributes are highlighted (e.g., through more prominent and relevant batching, dynamic item images shown to users, etc.), and targeting the nutritional attributes of interest to a specific user of the online system 140. For example, the user may be more health conscious about choosing breakfast bars (e.g., as identified based on substantial user' interaction with the nutrition information on product detail pages (PDP) of the breakfast bars) but may be less health conscious about choosing some other items (e.g., yogurt smoothies, juices, etc.). As most sources have “health” departments, the online system 140 can leverage this knowledge to prioritize the breakfast bars within the ranking of which items to display to the user as part of the “health” department. If that same user searches for breakfast bars, the online system 140 presented herein can increase the relevance of the healthy breakfast bars compared to when the user searches for, e.g., smoothies.

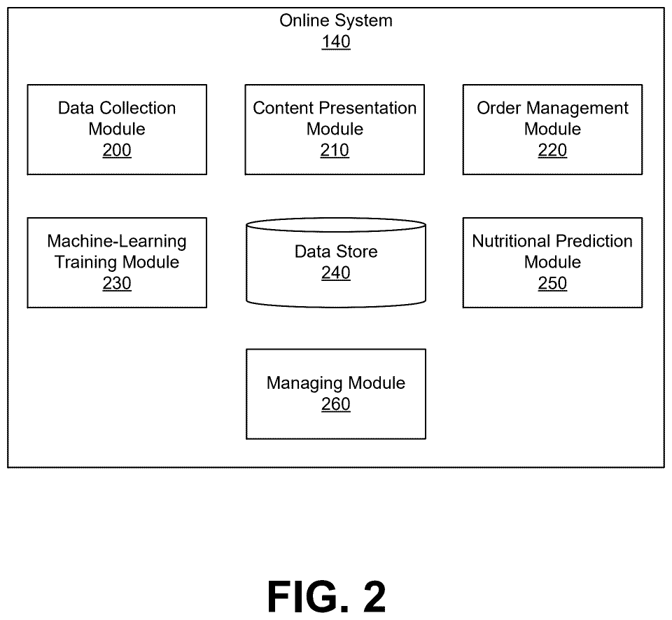

The online system 140 presented herein can improve the user experience by leveraging the personalized nutritional information predicted by the train model and optimize recommendations of items, displaying of items, and offerings of items across various omnichannel solutions associated with the online system 140. This can be achieved by applying the trained model that learns about nutrition preferences more specifically through users' interactions with the nutrition information on PDPs. The outputs of the trained model may be integrated with the omnichannel solutions of the online system 140, such as utilizing in-store item tags, in-store applications of the online system 140 running on user client devices 140, smart shopping carts 150, etc. The online system 140 is described in further detail below with regards to FIG. 2.

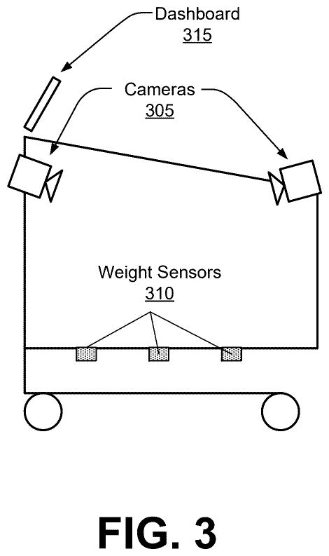

The smart shopping cart 150 is an in-store shopping cart that enables a user of the online system 140 to physically add (i.e., place) items from a source location (e.g., store) into the smart shopping cart 150 and check the items out from the source location without an involvement of an employee of the source at the point of sale. The smart shopping cart 150 may be connected to the online system 140 via the network 130. During the user's shopping session, the smart shopping cart 150 may utilize various sensors (e.g., one or more weight sensors, one or more cameras, etc.) to gather data about the user's activity, including, but not limited to, a location of the smart shopping cart 150 at the source location, weight changes of the smart shopping cart 150 as items are added to or removed from the smart shopping cart 150, video of the user's activity in and around the smart shopping cart 150, images of items added to the smart shopping cart 150, video and/or images of shelfs with items at the source location, etc. In one or more embodiments, the smart shopping cart 150 is considered being a part of the online system 140. It should be noted that the concepts described herein in relation to the smart shopping cart 150 can be extended and/or applied to other form factors, such as a handheld shopping basket, a handheld receptacle, or some other handheld object that can be used to receive and store shopping items. The smart shopping cart 150 is described in further detail below with regards to FIG. 3.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a nutritional prediction module 250, and a managing module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The nutritional prediction module 250 may access a nutritional prediction model (e.g., machine-learning model) that is trained to predict nutritional preferences for a given user of the online system 140, where the nutritional preferences are represented by corresponding nutritional attributes. The nutritional prediction module 250 may deploy the nutritional prediction model to run a machine-learning algorithm to output, based on a set of inputs, a vector of scores for a particular user of the online system 140, where each vector dimension corresponds to a different nutritional attribute. Thus, each score may be indicative of a user's preference in relation to a corresponding nutritional attribute. Each score may be a value between 0 and 1, and a higher value of the score indicates a higher user's preference for a corresponding nutrient (i.e., nutritional ingredient). For example, a value of the score that is higher than a threshold score (e.g., 0.5) may be indicative that the user prefers the corresponding nutrient. A set of parameters for the nutritional prediction model may be stored at one or more non-transitory computer-readable media of the nutritional prediction module 250. Alternatively, the set of parameters for the nutritional prediction model may be stored at one or more non-transitory computer-readable media of the data store 240.

The nutritional prediction module 250 may provide the set of inputs representing various input features to the nutritional prediction model. In providing the set of inputs to the nutritional prediction model, the nutritional prediction module 250 may provide data with information about historical actions performed by a user of the online system 140, such as purchase history for the user (i.e., users' prior purchase data), nutritional labels of items previously purchased by the user, filters (e.g., health-related filters) applied by the user when searching for items, health attribute search terms from past search queries entered by the user via a search interface of the user client device 100 (e.g., low-calorie, keto, vegan, high-protein, organic, etc.), user's interaction with “compare items feature” of an application of the online system 140 running on the user client device 100, some other user-related data, or some combination thereof. The data with information about the user's historical actions may be received at the online system 140 over time, via the network 130, from the user client device 100 and/or smart shopping carts 150 for in-store shopping utilized by the user and stored at a user database maintained at, e.g., the data store 240. The nutritional prediction module 250 may then retrieve the data with information about the user's historical actions from the user database.

The prior purchase data provided to the nutritional prediction model may include information about user health preferences. Items purchased frequently would be familiar to the user and be excluded from additional attribution. Data with information about the “compare items feature” selection provided to the nutritional prediction model may be obtained via a feature of the application of the online system 140 running on the user client device 100 that allows users to compare nutrition facts of two items side by side and select an item based on the side-by-side comparison. The nutritional prediction model may use the “compare items feature” selection data to determine additional information about what the user prioritizes in their nutrition by which items they select from the side-by-side comparison.

The data with information about nutritional labels of items previously purchased by the user provided to the nutritional prediction model may represent user's nutrition label engagement data. The nutrition label engagement data may include information about what ingredients/health information the user views and whether or not the user subsequently adds the corresponding item to a cart. If the user views the nutrition information and then adds an item to a cart, the nutritional prediction model may use this information to determine that the user is health conscious and a specific attribute or ingredient (or lack of ingredient) of the item appeals to the user. In contrast, if the user adds an item to a cart, then views the nutritional information and removes the item from the cart, the nutritional prediction model may use this information to determine that the health attributes of this item do not match the user's preferences.

In providing the set of inputs to the nutritional prediction model, the nutritional prediction module 250 may further provide data with information about item features, such as nutritional information of items including information about nutritional attributes of items, information about ingredients of items, consumer packaged goods (CPG) information, some other item information, or some combination thereof. The nutritional prediction module 250 may retrieve the data with information about the item features from an item catalog database maintained at, e.g., the data store 240.

In providing the set of inputs to the nutritional prediction model, the nutritional prediction module 250 may further provide data with information about source features, such as information about a type of a retail store where the user is currently purchasing items (e.g., either online or using the smart shopping cart 150). The type of retail store may be directly related to a type of shopping conducted by the user. For example, the user may be more interested in value-size attributes during a stocking-up shopping trip to a particular type of retail store, and more interested in an organic attribute when planning their family's dinner for that night when purchasing items in some other type of a retail store. The nutritional prediction module 250 may receive the data with information about source features from the source computing system 120 via the network 130.

FIG. 3 illustrates an example smart shopping cart 150 associated with the online system 140, in accordance with one or more embodiments. The smart shopping cart 150 may have one or more cameras 305 that collect video data and/or image data in relation to shelfs (i.e., store aisles) with various stored items as a user that utilizes the smart shopping cart 150 for in-store shopping is passing by. The one or more cameras 305 may further collect video data and/or image data in relation to items placed in the smart shopping cart 150, such as a weight of each item as indicated in an item label, a brand of each item, a name of each item, a price of each item, etc. Additionally, the one or more cameras 305 may collect video data and/or image data in relation to actions in and around the smart shopping cart 150, such as a location of the smart shopping cart 150 at a source location (e.g., store) when a certain action occurs (e.g., when an item is added to the cart), user's gestures when placing items in the smart shopping cart 150, video and/or images of user's interactions with the smart shopping cart 150, track the location of the user within the source location, measure a velocity of the smart shopping cart 150 in the source location, etc. Alternatively or additionally, the smart shopping cart 150 may be equipped with one or more weight sensors 310 that measure weights of items placed in the smart shopping cart 150.

The smart shopping cart 150 may further include a dashboard 315 that operates as a user interface that displays a list of items added to a receptacle of the smart shopping cart 150 and can be used for the checkout. The dashboard 315 may be further used for providing notifications to the user that utilizes the smart shopping cart 150 for in-store shopping. The smart shopping cart 150 may include additional sensors not shown in FIG. 3. The dashboard 315 or some other component of the smart shopping cart 150 may further include a computing system that is in communication with the user client device 100, the source computing system 120 and/or the online system 140 via the network 130. Data gathered by various sensors of the smart shopping cart 150 may be uploaded via the network 130 at the online system 140 (e.g., via the nutritional prediction module 250) to be stored at the data store 240 and later retrieved as input features for the nutritional prediction model, such as information about nutritional labels and ingredients of items added to the smart shopping cart 150. Alternatively or additionally, data gathered by various sensors of the smart shopping cart 150 may be uploaded via the network 130 directly to the nutritional prediction module 250 and provided as input features to the nutritional prediction model.

The nutritional prediction model outputs a vector of scores for a particular user of the online system 140 and each score is indicative of a user's preference in relation to a different nutritional attribute. Hence, the nutritional prediction model may actually determine a preferred set of nutritional attributes for each user, as the preferred set of nutritional attributes may be associated with a set of scores higher than one or more threshold scores. The online system 140 may then utilize this information to highlight (e.g., via the content presentation module 210), to each user, any nutritional attribute that belongs to the user's preferred set of nutritional attributes that is found in an item displayed via a user interface of the user client device 100 or a user interface of the dashboard 315. The online system 140 may highlight (e.g., by sending corresponding signals via the content presentation module 210 and the network 130) the user's preferred nutritional attributes on specific items in an in-store application of the online system 140 running on the user client device 100. Furthermore, the online system 140 may highlight (e.g., by sending corresponding signals via the content presentation module 210 and the network 130) the user's preferred nutritional attributes on specific items when the user scans shelf labels at a retail store via a user interface of the user client device 100.

Based on outputs of the nutritional prediction model, the online system 140 may apply certain filters and visuals that users see throughout their shopping journey. For example, the online system 140 may generate (e.g., via the content presentation module 210) a user interface of the user client device 100 or a user interface of the dashboard 315 with appropriate pictures of packaging vs. the item, generated aisle images and collections to bring nutrition attributes, or entire items within aisles, to the forefront of the shopping experience. In general, based on outputs of the nutritional prediction model, the online system 140 may generate (e.g., via the content presentation module 210) a user interface of the user client device 100 or a user interface of the dashboard 315 that is personalized to each user's needs and/or interests.

The machine-learning training module 230 may perform initial training of the nutritional prediction model using training data. The machine-learning training module 230 may generate the training data by generating labels associated with nutritional attributes based on profiles of a collection of users of the online system 140, search history of the collection of users, purchase history of the collection of users (e.g., as available at the data store 240), using existing catalog of attributes (e.g., at the data store 240), etc. Additionally or alternatively, the machine-learning training module 230 may generate the training data by gathering users' preferences for nutritional attributes from users' profiles obtained from various sources associated with the online system 140. The online system 140 may further prompt (e.g., via the content presentation module 210) each user from collection of users to confirm the collected labels. The machine-learning training module 230 may train the nutritional prediction model using the training data to generate initial values for the set of parameters of the nutritional prediction model.

The machine-learning training module 230 may collect engagement data in relation to nutritional attribute identified items displayed to users of the online system 140. The engagement data may include viewing data and subsequent conversion data in relation to the nutritional attribute identified items, i.e., the engagement data my include information about nutritional preferences of the users. For example, the engagement data include information that a particular user of the online system 140 is more likely to interact with items that have a certain attribute label or image shown, the nutritional prediction model will learn to preference that attribute for appropriate items. The machine-learning training module 230 may then re-train the nutritional prediction model by updating the set of parameters of the nutritional prediction model using the collected engagement data.

Based on the vector of scores output by the nutritional prediction model where each score in the vector is indicative of a user's preference in relation to a different nutritional attribute, the managing module 260 may trigger one or more actions is relation to how a user interface of the online system 140 (e.g., user interface of the user client device 100, a user interface at the dashboard 315 of the smart shopping cart 150, etc.) is generated to present nutritional attributes that are of interest to a specific user of the online system 140. Based on the vector of scores, the managing module 260 may retrieve, from an item catalog database (e.g., stored at the data store 240), a corresponding image for an item for presentation to the user via the user interface that is suitable to user's nutritional attribute preferences. For example, if a user has a high score for calorie counting, the managing module 260 may retrieve, from the item catalog database, a corresponding image for an item with a nutritional calorie label.

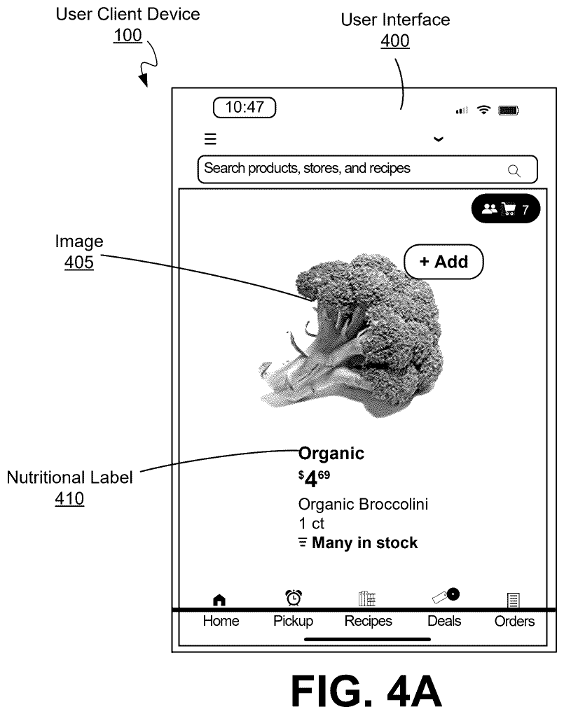

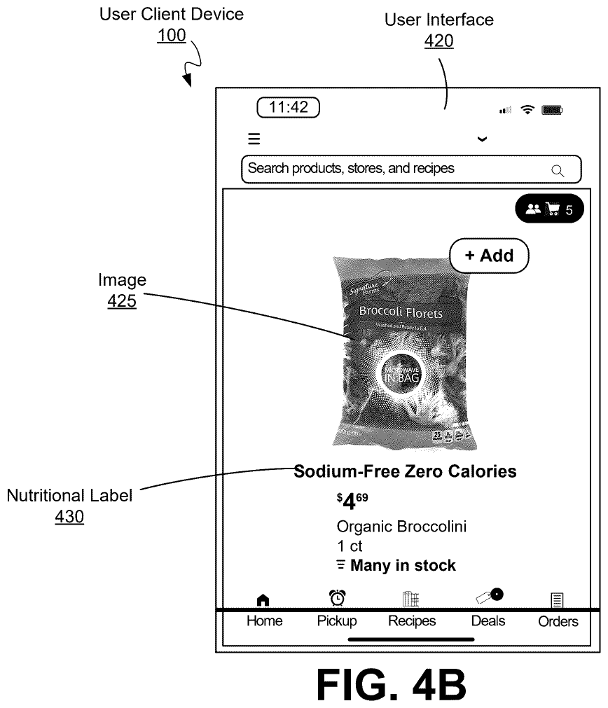

In one or more embodiments, based on a vector of scores for a given user of the online system 140 output by the nutritional prediction model, the online system 140 can learn that the user is health conscious, and particularly cares about minimizing additives and prefers natural ingredients. In such cases, the managing module 260 may generate a user interface of the online system 140 that would highlight one or more nutritional attributes (e.g., organic attribute) and show images of fresh foods without packaging. FIG. 4A illustrates an example user interface 400 with an image 405 of an item (e.g., “Organic Broccolini”) displayed at the user client device 100, in accordance with one or more embodiments. The image 405 is a fresh food image of the item and is retrieved, along with a corresponding nutritional label 410 (e.g., “Organic”), from the item catalog database by the managing module 260 based on a vector of scores predicted for a given user by the nutritional prediction model. The managing module 260 may provide the retrieved image 405 and the nutritional label 410 to the content presentation module 210. And the content presentation module 210 can then cause the user interface 400 to display the image 405 along with the nutritional label 410, as shown in FIG. 4A.

In one or more embodiments, based on a vector of scores for a given user of the online system 140 output by the nutritional prediction model, the online system 140 can detect that the user is health-conscious by particularly prioritizing nutrition information and counting macros. For this user, the managing module 260 may generate a user interface of the online system 140 that would highlight nutritional attributes like low-calorie, surface a nutrition label image when they click on a PDP associated with the item, or highlight high protein/low carb foods in a carousel.

FIG. 4B illustrates an example user interface 420 with an item (e.g., “Organic Broccolini”) displayed at the user client device 100 that highlights specific nutritional attributes of the item, in accordance with one or more embodiments. An image 425 of the item and an appropriate nutritional label 430 (e.g., “Sodium-Free Zero Calories”) can be retrieved from the item catalog database by the managing module 260 based on a vector of scores predicted for a given user by the nutritional prediction model. The managing module 260 may provide the image 425 and the nutritional label 430 to the content presentation module 210. And the content presentation module 210 can then cause the user interface 400 to display the image 425 along with the nutritional label 430, as shown in FIG. 4B. Hence, both users associated with the user interfaces 400 and 420 would be likely to order a crown of organic broccoli, but a first user associated with the user interface 400 of FIG. 4A would be more interested in the ‘organic’ attributes as predicted by the nutritional prediction model, and a second user associated with the user interface 420 of FIG. 4B would be more interested in ‘healthy choice’ attributes.

In one or more embodiments, based on a vector of scores for a given user of the online system 140 output by the nutritional prediction model, the managing module 260 generates a user interface of the online system 140 where images associated with an item are shown in an order that corresponds to predicted user preferences for nutritional attributes. For example, the user interface can show a nutrition label first for macro-counting users. Additionally or alternatively, based on the vector of scores for a given user, the managing module 260 may generate the user interface that highlights a specific nutrition or attribute information in the PDP information about an item. Additionally or alternatively, based on the vector of scores for a given user, the managing module 260 may generate the user interface with the ‘details pop ups’ feature that appears upon item tile hover, i.e., the detailed information about the nutrition or item attribute of interest is shown when the user hovers over the item.

Additionally or alternatively, based on the vector of scores for a given user, the managing module 260 may generate the user interface with appropriate item tile images. For example, the managing module 260 may generate the user interface that shows less packaging for users who shop fresh food and/or whole food, or show images with keto-friendly item packaging labels. Additionally or alternatively, based on the vector of scores for a given user, the managing module 260 may generate the user interface with appropriate item tile badges, i.e., the item attributes that are on item tiles are personalized in accordance with predicted user's preferences for nutritional attributes. Additionally or alternatively, based on vectors of scores for a collection of users of the online system 140 as output by the nutritional prediction model, the managing module 260 may generate attribute specific collections of items (e.g., at the data store 240) by creating collections of items that all share a same attribute of interest. Items from a corresponding collection would be then surfaced (e.g., via the content presentation module 210) to only those users with predicted preferences for a nutritional attribute shared by the items in the collection.

In one or more embodiments, based on a vector of scores for a given user of the online system 140 output by the nutritional prediction model, the managing module 260 generates a user interface of the online system 140 having a tag with nutritional attribute next to an item when the user is browsing online. In such cases, the user interface may be displayed with altered tags to highlight the best nutritional facets for a user that utilizes an in-store application of the online system 140 running on the user client device 100. For example, the online system 140 may detect when the user is approaching a given item on a shelf (e.g., by communicating with the user client device 100 via the network 130) and dynamically update an item tag to show the nutritional attribute that is most relevant to the user (e.g., low sodium or gluten free), based on the predicted user's preferences.

In one or more embodiments, based on a vector of scores for a given user of the online system 140 output by the nutritional prediction model, the managing module 260 generates a message to be displayed at the dashboard 315 of the smart shopping cart 150 with information about one or more nutritional attributes for an item when sensors of the smart shopping cart 150 (or cameras at a grocery store) detect that the user is approaching the item at the grocery store. Alternatively, based on the vector of scores, the managing module 260 may trigger updating of an in-store tag on a shelf of a grocery store where an identified item that the user is approaching is located. The in-store tag at the shelf may be updated (e.g., by sending corresponding digital signals from the managing module 260 to the grocery store via the network 130) to show one or more nutritional attributes of the item that are of interest for the user.

In one or more embodiments, based on a vector of scores for a given user of the online system 140 output by the nutritional prediction model, the managing module 260 generates an alert message to be shown at a user interface of the user client device when the user adds an item to a shopping cart that is inconsistent with one or more nutritional attributes that user cares about. The user interface of the user client device 100 may further show key nutritional information about the item as the item enters the shopping cart, based on the predicted user's nutritional preferences.

Similarly, based on a vector of scores for a given user of the online system 140 output by the nutritional prediction model, the managing module 260 generates an alert message to be shown at the dashboard 315 of the smart shopping cart 150 when the user places an item into the smart shopping cart 150 that is inconsistent with one or more nutritional attributes that user cares about. The user interface at the dashboard 315 may further show key nutritional information about the item as the item is placed into the smart shopping cart 150, based on the predicted user's nutritional preferences. For example, the user can place an item into the smart shopping cart 150 that is high in sodium. However, the nutritional prediction model identifies that the user aims to reduce their sodium intake based on how they have perused the nutritional information of items that are high or low in sodium. In such cases, the managing module 260 can generate an alert message to be shown at the dashboard 315 of the smart shopping cart 150 that the item placed into the smart shopping cart 150 is not low in sodium.

In one or more embodiments, based on a vector of scores for a given user of the online system 140 output by the nutritional prediction model, the managing module 260 ranks items that are retrieved from the item catalog database (e.g., in response to a user's search query) and generates a user interface of the online system 140 that shows only a defined number of highest ranked items. For example, when the user is identified by the nutritional prediction model as a highly health-conscious user, the highest ranked items shown to the user can be one or more items with the healthiest nutrients. Additionally or alternatively, the online system 140 can utilize outputs of the nutritional prediction model for a collection of users of the online system 140 to define an audience for a health-focused ad targeting. The audience may include all users from the collection of users with a score above a threshold score for a particular dimension of in vectors of scores output for the collection of users by the nutritional prediction model. For example, in this manner, the online system 140 can improve ad targeting for brands that want to identify health-conscious users.

The online system 140 with the integrated nutritional prediction model presented herein may further facilitate health-oriented shopping of individual users of the online system 140. By generating personalized user interfaces, the online system 140 may allow users to easily identify items that meet their prescribed dietary requirements. Additionally or alternatively, the online system 140 may leverage outputs of the nutritional prediction model to generate user interfaces that highlight food items as medicine products and surface this information to relevant users. In such cases, healthcare providers that collaborate with the online system 140 can prescribe a ‘diabetic friendly’ or ‘elimination diet’ regimen for their patients to follow, which can be then easily identified at user interfaces of the online system 140.

The online system 140 with the integrated nutritional prediction model presented herein may further facilitate allergy-aware shopping of individual users of the online system 140. Generated personalized user interfaces of the online system 140 may highlight allergy free attributes to those users of the online system 140 that are identified via the nutritional prediction model as allergic to one or more nutritional attributes. Additionally or alternatively, the online system 140 may filter out (e.g., via the managing module 260) those items that are associated with nutritional attributes to which a specific user is allergic. Then, the content presentation module 210 would not show any item at the user interface that does not meet user's allergy requirements. Alternatively, when specific items are explicitly requested by a user, the managing module 260 may generate the user interface that flags those items that contain one or more nutritional attributes to which the user is allergic.

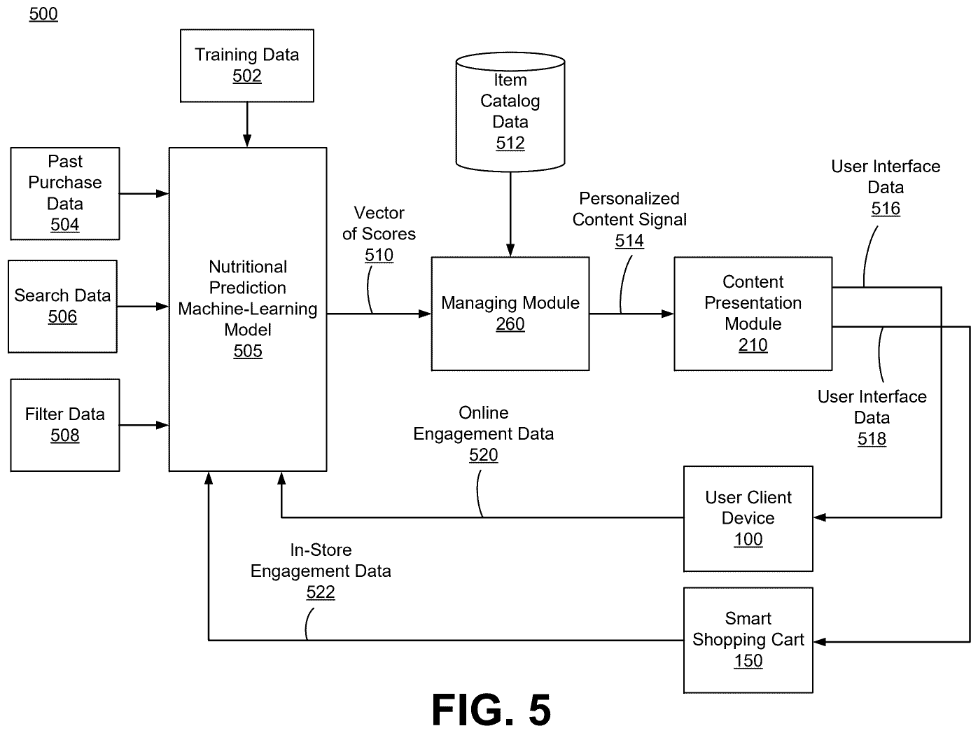

FIG. 5 illustrates an example architectural flow diagram 500 of using a nutritional prediction machine-learning model 505 to predict preferences for nutritional attributes of items for a user of the online system 140, in accordance with one or more embodiments. First, the online system 140 may perform (e.g., via the machine-learning training module 230) initial training of the nutritional prediction machine-learning model 505 using training data 502 to generate initial values for the set of parameters of the nutritional prediction machine-learning model 505. The training data 502 may be generated (e.g., via the machine-learning training module 230) by gathering users' preferences for nutritional attributes from users' profiles obtained from various sources associated with the online system 140, assigning labels associated with nutritional attributes based on search history of a collection of users the online system 140, assigning labels associated with nutritional attributes based on purchase history of the collection of users, etc. After the training process is completed, the online system 140 may provide various inputs to the nutritional prediction machine-learning model 505 (e.g., via the nutritional prediction module 250), such as past purchase data 504, search data 506, and/or filter data 508. Some additional input features not shown in FIG. 5 suitable for predicting user's preferences for nutritional attributes of items may be further provided to the nutritional prediction machine-learning model 505.

In providing the past purchase data 504 to the nutritional prediction machine-learning model 505, the online system 140 may provide (e.g., via the nutritional prediction module 250) information about purchase history for a user, information about nutritional labels of items previously purchased by the user, information about user's health preferences, information about items frequently purchased by the user, some other past purchase information for the user, or some combination thereof. The past purchase data 504 may be received over time at the online system 140 from the user client device 100 and/or the smart shopping cart 150 via the network 130 and stored into, e.g., the data store 240. The nutritional prediction module 250 may then retrieve the past purchase data 504 from the data store 240.

In providing the search data 506 to the nutritional prediction machine-learning model 505, the online system 140 may provide (e.g., via the nutritional prediction module 250) information about search history for the user including information about health attribute search terms from past search queries entered by the user via a search interface of the user client device 100 (e.g., low-cal, keto, vegan, high-protein, organic, etc.). The search data 506 may be received over time at the online system 140 from the user client device 100 via the network 130 and stored into, e.g., the data store 240. The nutritional prediction module 250 may then retrieve the search data 506 from the data store 240.

In providing the filter data 508 to the nutritional prediction machine-learning model 505, the online system 140 may provide (e.g., via the nutritional prediction module 250) information about filters (e.g., health-related filters, diet-related filters, nutrient-related filters, etc.) applied by the user when searching for items at a user interface of the user client device 100. The filter data 508 may be received over time at the online system 140 from the user client device 100 via the network 130 and stored into, e.g., the data store 240. The nutritional prediction module 250 may then retrieve the filtering data 508 from the data store 240.

The nutritional prediction machine-learning model 505 may apply a machine-learning algorithm to the past purchase data 504, the search data 506, and/or the filter data 508 to output a vector of scores 510 for the user, where each score in the vector of scores 510 corresponds to a different nutritional attribute and is indicative of a user's preference in relation to a corresponding nutritional attribute. Each score in the vector of scores 510 may be a value between 0 and 1, and a higher value of the score indicates a higher user's preference for a corresponding nutritional attribute. The vector of scores 510 output by the nutritional prediction machine-learning model 505 may be passed to the managing module 260. Some additional input features not shown in FIG. 5 suitable for predicting user's preferences for nutritional attributes of items may be further provided to the nutritional prediction machine-learning model 505.

The managing module 260 may generate, based on the vector of scores 510 and item catalog data 512 (e.g., retrieved from the data store 240) personalized content signal 514 that includes information about content to be presented to the user that is personalized for the user. The personalized content signal 514 can be used to prominently display, at a user interface of the online system 140 utilized by the user, information about nutritional attributes that the user cares about as indicated by the vector of scores 510. The managing module 260 may pass the personalized content signal 514 to the content presentation module 210.

The content presentation module 210 may use the personalized content signal 514 to generate user interface data 516 and/or user interface data 518. The content presentation module 210 may cause, based on the user interface data 516, a user interface of the user client device 100 to display personalized content for the user that highlight nutritional attributes that the user cares about, as well as appropriate images of items, nutritional tags, alert messages if the user added an item to a shopping cart that is not in compliance with the user's nutritional preferences, etc. Similarly, the content presentation module 210 may cause, based on the user interface data 518, the dashboard 315 of the smart shopping cart 150 to display personalized content for the user that highlight nutritional attributes that the user cares about, as well as appropriate images of items, nutritional tags, alert messages if the user placed an item into the smart shopping cart 150 that is not in compliance with the user's nutritional preferences, etc.

Upon generating the user interface at the user client device 100, the user client device 100 may generate online engagement data 520 with information about the user's engagement with the items displayed at the user interface of the user client device 100. The online engagement data 520 may include information about the user's conversion of one or more items, information about the user's browsing through displayed nutritional content, information about the user's response to any alert messages displayed at the user interface, some other online feedback information from the user, or some combination thereof. The online system 140 may receive (e.g., via the machine-learning training module 230) the online engagement data 520 from the user client device 100 via the network 130. The machine-learning training module 230 may utilize the online engagement data 520 to re-train the nutritional prediction machine-learning model 505. By utilizing the online engagement data 520, the machine-learning training module 230 may update the set of parameters of the nutritional prediction machine-learning model 505 and continuously improve the machine-learning algorithm of the nutritional prediction machine-learning model 505.

Similarly, upon generating the user interface at the dashboard 315 of the smart shopping cart 150, the computing system of the smart shopping cart 150 may generate in-store engagement data 522 with information about the user's engagement while conducting in-store shopping by utilizing the smart shopping cart 150 in response to the personalized content with nutritional attributes displayed at the dashboard 315. The in-store engagement data 522 may include information about the one or more items scanned via the smart shopping cart 150 in response to the generated user interface, information about a movement of the smart shopping cart 150 through the store in response to the generated user interface, information about user's response to any alert messages displayed at the dashboard 315, some other in-store feedback information, or some combination thereof. The online system 140 may receive (e.g., via the machine-learning training module 230) the in-store engagement data 522 from the smart shopping cart 150 via the network 130. The machine-learning training module 230 may utilize the in-store engagement data 522 to re-train the nutritional prediction machine-learning model 505. By utilizing the in-store engagement data 522, the machine-learning training module 230 may update the set of parameters of the nutritional prediction machine-learning model 505 and continuously improve the machine-learning algorithm of the nutritional prediction machine-learning model 505.

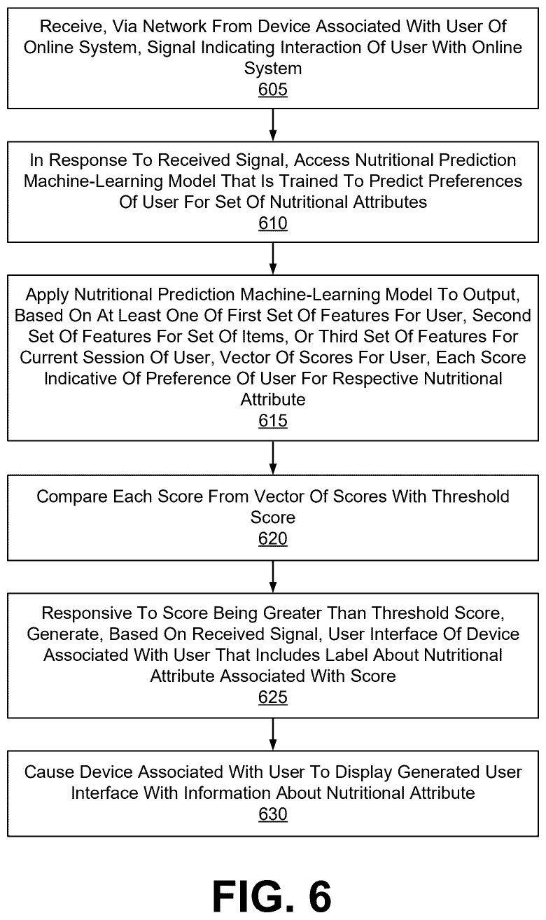

FIG. 6 is a flowchart for a method of using a trained machine-learning model of an online system to predict preferences for nutritional attributes of items for a user of the online system, in accordance with one or more embodiments. Alternative embodiments may include more, fewer, or different steps from those illustrated in FIG. 6, and the steps may be performed in a different order from that illustrated in FIG. 6. These steps may be performed by an online system (e.g., the online system 140). Additionally, each of these steps may be performed automatically by the online system without human intervention.

The online system 140 receives 605 (e.g., at the nutritional prediction module 250), via a network (e.g., the network 130) from a device associated with a user of the online system 140 (e.g., the user client device 100 or the smart shopping cart 150), a signal indicating interaction of the user with the online system 140. In response to the received signal, the online system 140 accesses 610 a nutritional prediction machine-learning model of the online system 140 (e.g., via the nutritional prediction module 250), wherein the nutritional prediction model is trained to predict preferences of the user for a set of nutritional attributes. The online system 140 applies 615 the nutritional prediction machine-learning model (e.g., via the nutritional prediction module 250) to output, based on at least one of a first set of features for the user, a second set of features for a set of items, and a third set of features for a current session of the user, a vector of scores for the user, each score from the vector of scores indicative of a preference of the user for a respective nutritional attribute of the set of nutritional attributes.

The online system 140 compares 620 (e.g., via the nutritional prediction module 250) each score from the vector of scores with a threshold score. Responsive to a score from the vector of scores being greater than the threshold score, the online system 140 generates 625 (e.g., via the managing module 260), based at least in part on the received signal, a user interface of the device associated with the user that includes label about the nutritional attribute associated with the score. The online system 140 causes 630 (e.g., via the content presentation module 210) the device associated with the user to display the generated user interface with the label about the nutritional attribute.

In one or more embodiments, the online system 140 receives the signal by receiving (e.g., at the nutritional prediction module 250), from the device associated with the user via the network, a request for an item. The online system 140 may then generate (e.g., via the managing module 260) the user interface that includes a tag with the nutritional attribute associated with the item. And the online system 140 may cause (e.g., via the content presentation module 210) the device associated with the user to display the user interface that includes the tag with the nutritional attribute next to the item. Alternatively, upon receiving the request for the item, the online system 140 may retrieve (e.g., via the managing module 260), from a catalog database of the online system 140 (e.g., at the data store 240) and based on one or more scores from the vector of scores being greater than one or more threshold scores, an image associated with the item. The online system 140 may then generate (e.g., e.g., via the managing module 260) one or more nutritional labels associated with the one or more scores. And the online system 140 may cause (e.g., via the content presentation module 210) the device associated with the user to display the user interface that includes the retrieved image and the one or more nutritional labels.

In one or more embodiments, the online system 140 gathers, via one or more sensors mounted to a physical receptacle (e.g., the smart shopping cart 150) utilized by the user for shopping at a location of a source associated with the online system 140, data with information about an item. The online system 140 may then receive (e.g., at the nutritional prediction module 250), from a computing system associated with the physical receptacle and via the network, the gathered data as the received signal. The online system 140 may generate, based at least in part on the gathered data, a message at a dashboard of the physical receptacle (e.g., the dashboard 315 of the smart shopping cart 150) that includes the label about the nutritional attribute associated with the item.

In one or more embodiments, the online system 140 gathers, via one or more sensors mounted to the physical receptacle utilized by the user for shopping at the source location, data with indication that the user is approaching an item placed at a shelf at the source location. The online system 140 may then receive, from a computing system associated with the physical receptacle and via the network, the gathered data as the received signal. The online system 140 may then generate the user interface by updating (e.g., via the managing module 260) a tag on the shelf with the label about the nutritional attribute associated with the item.

In one or more embodiments, the online system 140 receives (e.g., at the nutritional prediction module 250), from the device associated with the user via the network, information that the user added an item to a cart. Responsive to each score of a subset of scores from the vector of scores associated with the item being less than or equal to the threshold score, the online system 140 may generate (e.g., via the managing module 260) another user interface of the device associated with the user that includes an alert message for the user that the item is not consistent with the predicted preferences of the user. The online system 140 may then cause (e.g., via the content presentation module 210) the device associated with the user to display the other user interface with the alert message.

In one or more embodiments, the online system 140 gathers, via one or more sensors mounted to the physical receptacle utilized by the user for shopping at the source location, data with information about an item added into the physical receptacle. Responsive to each score of a subset of scores from the vector of scores associated with the item being less than or equal to the threshold score, the online system 140 may generate (e.g., via the managing module 260) a user interface at the dashboard of the physical receptacle that includes an alert message for the user that the item is not consistent with the predicted preferences of the user. The online system 140 may then cause (e.g., via the content presentation module 210) the dashboard of the physical receptacle to display the user interface with the alert message.

In one or more embodiments, the online system 140 receives (e.g., at the nutritional prediction module 250), from the device associated with the user via the network, a search query entered by the user via a search interface of the device. Based on the search query, the online system 140 may retrieve (e.g., via the managing module 260) the set of items from the catalog database. The online system 140 may then rank (e.g., via the managing module 260), based at least in part on the vector of scores, the set of items to generate a ranked list of items, and select, from the ranked list of items, a subset of items for presentation to the user. To generate the subset of items, the online system 140 may filter (e.g., via the managing module 260), based at least in part on the vector of scores, one or more items from the ranked list of items. The online system 140 may cause (e.g., via the content presentation module 210) the device associated with the user to display the user interface with the subset of items and information about one or more nutritional attributes for each of the subset of items.

In one or more embodiments, the online system 140 retrieves (e.g., via the nutritional prediction module 250), from the catalog database, the first set of features including at least one of information about a purchase history for the user, information about nutritional labels of items previously purchased by the user, and a set of health attributes from past search queries entered by the user via the user client device. The online system 140 may further retrieve (e.g., via the nutritional prediction module 250), from the catalog database, the second set of features including at least one of nutritional information for the set of items and information about ingredients for the set of items. Additionally, the online system 140 may receive (e.g., at the nutritional prediction module 250), from the user client device via the network, the third set of features including one or more features of a source associated with the current session of the user and information about a type of shopping associated with the current session of the user.

In one or more embodiments, the online system 140 retrieves (e.g., via the machine-learning training module 230), from the catalog database, data including at least one of a collection of profiles for a collection of users of the online system 140, search history for the collection of users, and purchase history for the collection of users. The online system 140 may generate (e.g., via the machine-learning training module 230) training data by assigning labels to nutritional attributes associated with the retrieved data. The online system 140 may train (e.g., via the machine-learning training module 230), using the training data, the nutritional prediction machine-learning model to generate a set of initial values for the set of parameters of the nutritional prediction machine-learning model. Furthermore, the online system 140 may collect (e.g., via the machine-learning training module 230) feedback data with information about engagement by the user with one or more items for which information about one or more nutritional attributes is displayed at the user interface. The online system 140 may re-train the nutritional prediction machine-learning model by updating (e.g., via the machine-learning training module 230), using the collected feedback data, the set of parameters of the nutritional prediction machine-learning model.

Embodiments of the present disclosure are directed to the online system 140 that utilizes a trained machine-learning model to predict preferences for nutritional attributes of items for a specific user of the online system 140. The machine-learning model integrated into the online system 140 is trained to score the specific user in different categories of nutritional attribute (e.g., health attribute) interest. The online system 140 uses scores for the specific user in relation to their preferences for nutritional attribute generate a personalized user interface with information about nutritional attributes that are of user's interest.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network from a device associated with a user of an online system, a signal indicating interaction of the user with the online system;
in response to the received signal, accessing a nutritional prediction machine-learning model of the online system, wherein the nutritional prediction machine-learning model is trained to predict preferences of the user for a set of nutritional attributes;
applying the nutritional prediction machine-learning model to output, based on at least one of: a first set of features for the user, a second set of features for a set of items, or a third set of features for a current session of the user, a vector of scores for the user, each score from the vector of scores indicative of a preference of the user for a respective nutritional attribute of the set of nutritional attributes;
comparing each score from the vector of scores with a threshold score;
responsive to a score from the vector of scores being greater than the threshold score, generating, based at least in part on the received signal, a user interface of the device associated with the user that includes a label about a nutritional attribute from the set of nutritional attributes associated with the score; and
causing the device associated with the user to display the generated user interface with the label about the nutritional attribute.

2. The method of claim 1, wherein:
receiving the signal comprises receiving, from the device associated with the user via the network, a request for an item;
generating the user interface comprises generating the user interface that includes a tag with the nutritional attribute associated with the item; and
displaying the user interface comprises displaying the user interface that includes the tag with the nutritional attribute next to the item.

3. The method of claim 1, wherein:
receiving the signal comprises receiving, from the device associated with the user via the network, a request for an item;
generating the user interface comprises:
retrieving, from a catalog database of the online system and based on one or more scores from the vector of scores being greater than one or more threshold scores, an image associated with the item, and
generating one or more nutritional labels associated with the one or more scores; and
displaying the user interface comprises displaying the retrieved image and the one or more nutritional labels at the user interface.

4. The method of claim 1, wherein:
receiving the signal comprises:
gathering, via one or more sensors mounted to a physical receptacle utilized by the user for shopping at a location of a source associated with the online system, data with information about an item, and
receiving, from a computing system associated with the physical receptacle and via the network, the gathered data as the received signal; and
generating the user interface comprises generating, based at least in part on the gathered data, a message at a dashboard of the physical receptacle that includes the label about the nutritional attribute associated with the item.

5. The method of claim 1, wherein:
receiving the signal comprises:
gathering, via one or more sensors mounted to a physical receptacle utilized by the user for shopping at a location of a source associated with the online system, data with indication that the user is approaching an item placed at a shelf at the location of the source, and
receiving, from a computing system associated with the physical receptacle and via the network, the gathered data as the received signal; and
generating the user interface comprises updating a tag on the shelf with the label about the nutritional attribute associated with the item.

6. The method of claim 1, wherein receiving the signal comprises:
receiving, from the device associated with the user via the network, information that the user added an item to a cart, and the method further comprising:
responsive to each score of a subset of scores from the vector of scores associated with the item being less than or equal to the threshold score, generating another user interface of the device associated with the user that includes an alert message for the user that the item is not consistent with the predicted preferences of the user; and
causing the device associated with the user to display the other user interface with the alert message.

7. The method of claim 1, wherein receiving the signal comprises:
gathering, via one or more sensors mounted to a physical receptacle utilized by the user for shopping at a location of a source associated with the online system, data with information about an item added into the physical receptacle, and the method further comprising:
responsive to each score of a subset of scores from the vector of scores associated with the item being less than or equal to the threshold score, generating a user interface at a dashboard of the physical receptacle that includes an alert message for the user that the item is not consistent with the predicted preferences of the user; and
causing the dashboard of the physical receptacle to display the user interface with the alert message.

8. The method of claim 1, wherein:
receiving the signal comprises receiving, from the device associated with the user via the network, a search query entered by the user via a search interface of the device; and
generating the user interface comprises:
retrieving, from a catalog database of the online system and based on the search query, the set of items,
ranking, based at least in part on the vector of scores, the set of items to generate a ranked list of items, and
selecting, from the ranked list of items, a subset of items for presentation to the user; and
displaying the user interface comprises displaying the user interface with the subset of items and information about one or more nutritional attributes for each of the subset of items.

9. The method of claim 8, wherein selecting the subset of items comprises:
filtering, based at least in part on the vector of scores, one or more items from the ranked list of items to generate the subset of items.

10. The method of claim 1, further comprising:
retrieving, from a catalog database of the online system, the first set of features including at least one of information about a purchase history for the user, information about nutritional labels of items previously purchased by the user, and a set of health attributes from past search queries entered by the user via the device associated with the user;
retrieving, from the catalog database, the second set of features including at least one of nutritional information for the set of items and information about ingredients for the set of items; and
receiving, from the device associated with the user via the network, the third set of features including one or more features of a source associated with the current session of the user and information about a type of shopping associated with the current session of the user.

11. The method of claim 1, further comprising:
retrieving, from a catalog database of the online system, data including at least one of a collection of profiles for a collection of users of the online system, search history for the collection of users, and purchase history for the collection of users;
generating training data by assigning labels to nutritional attributes associated with the retrieved data; and
training, using the training data, the nutritional prediction machine-learning model to generate a set of initial values for a set of parameters of the nutritional prediction machine-learning model.

12. The method of claim 1, further comprising:
retrieving, from a catalog database of the online system, data including a collection of profiles for a collection of users of the online system, the collection of profiles including information about preferences of the collection of users for nutritional attributes; and
training, using the retrieved data, the nutritional prediction machine-learning model to generate a set of initial values for a set of parameters of the nutritional prediction machine-learning model.

13. The method of claim 1, further comprising:
collecting feedback data with information about engagement by the user with one or more items for which information about one or more nutritional attributes is displayed at the user interface; and
re-training the nutritional prediction machine-learning model by updating, using the collected feedback data, a set of parameters of the nutritional prediction machine-learning model.

14. A computer program product comprising a non-transitory computer readable storage medium having instructions encoded thereon that, when executed by a processor, cause the processor to perform steps comprising:
receiving, via a network from a device associated with a user of an online system, a signal indicating interaction of the user with the online system;
in response to the received signal, accessing a nutritional prediction machine-learning model of the online system, wherein the nutritional prediction machine-learning model is trained to predict preferences of the user for a set of nutritional attributes;
applying the nutritional prediction machine-learning model to output, based on at least one of: a first set of features for the user, a second set of features for a set of items, or a third set of features for a current session of the user, a vector of scores for the user, each score from the vector of scores indicative of a preference of the user for a respective nutritional attribute of the set of nutritional attributes;
comparing each score from the vector of scores with a threshold score;
responsive to a score from the vector of scores being greater than the threshold score, generating, based at least in part on the received signal, a user interface of the device associated with the user that includes a label about a nutritional attribute from the set of nutritional attributes associated with the score; and
causing the device associated with the user to display the generated user interface with the label about the nutritional attribute.

15. The computer program product of claim 14, wherein the instructions further cause the processor to perform steps comprising:
receiving, from the device associated with the user via the network, a request for an item;
generating the user interface that includes a tag with the nutritional attribute associated with the item; and
displaying the user interface that includes the tag with the nutritional attribute next to the item.

16. The computer program product of claim 14, wherein the instructions further cause the processor to perform steps comprising:
receiving, from the device associated with the user via the network, a request for an item;
retrieving, from a catalog database of the online system and based on one or more scores from the vector of scores being greater than one or more threshold scores, an image associated with the item;
generating one or more nutritional labels associated with the one or more scores; and
displaying the retrieved image and the one or more nutritional labels at the user interface.

17. The computer program product of claim 14, wherein the instructions further cause the processor to perform steps comprising:
gathering, via one or more sensors mounted to a physical receptacle utilized by the user for shopping at a location of a source associated with the online system, data with information about an item;
receiving, from a computing system associated with the physical receptacle and via the network, the gathered data as the received signal; and
generating, based at least in part on the gathered data, a message at a dashboard of the physical receptacle that includes the label about the nutritional attribute associated with the item.

18. The computer program product of claim 14, wherein the instructions further cause the processor to perform steps comprising:
gathering, via one or more sensors mounted to a physical receptacle utilized by the user for shopping at a location of a source associated with the online system, data with indication that the user is approaching an item placed at a shelf at the location of the source;
receiving, from a computing system associated with the physical receptacle and via the network, the gathered data as the received signal; and
generating the user interface by updating a tag on the shelf with the label about the nutritional attribute associated with the item.

19. The computer program product of claim 14, wherein the instructions further cause the processor to perform steps comprising:
retrieving, from a catalog database of the online system, data including at least one of a collection of profiles for a collection of users of the online system, search history for the collection of users, and purchase history for the collection of users;
generating training data by assigning labels to nutritional attributes associated with the retrieved data;
training, using the training data, the nutritional prediction machine-learning model to generate a set of initial values for a set of parameters of the nutritional prediction machine-learning model;
collecting feedback data with information about engagement by the user with one or more items for which information about one or more nutritional attributes is displayed at the user interface; and
re-training the nutritional prediction machine-learning model by updating, using the collected feedback data, the set of parameters of the nutritional prediction machine-learning model.

20. A computer system comprising:
a processor; and
a non-transitory computer-readable storage medium having instructions that, when executed by the processor, cause the computer system to perform steps comprising:
receiving, via a network from a device associated with a user of an online system, a signal indicating interaction of the user with the online system;
in response to the received signal, accessing a nutritional prediction model of the online system, wherein the nutritional prediction machine-learning model is trained to predict preferences of the user for a set of nutritional attributes;
applying the nutritional prediction machine-learning model to output, based on at least one of: a first set of features for the user, a second set of features for a set of items, or a third set of features for a current session of the user, a vector of scores for the user, each score from the vector of scores indicative of a preference of the user for a respective nutritional attribute of the set of nutritional attributes;
comparing each score from the vector of scores with a threshold score;
responsive to a score from the vector of scores being greater than the threshold score, generating, based at least in part on the received signal, a user interface of the device associated with the user that includes a label about a nutritional attribute from the set of nutritional attributes associated with the score; and
causing the device associated with the user to display the generated user interface with the label about the nutritional attribute.
